(19) United States
(12) Patent Application Publication
(10) Pub. No.: US 2005/0209818 A1
(43) Pub. Date: Sep. 22, 2005

(54) System and method for predicting a parameter for a lithography overlay first lot

(75) Inventors: Hung-Shun Chao, Taipei City (TW); Chun-Ming Hu, Hsin-Chu City (TW)

Correspondence Address: HAYNES AND BOONE, LLP, 901 MAIN STREET, SUITE 3100, DALLAS, TX, 75202, US

(73) Assignee: Taiwan Semiconductor Manufacturing Co., Ltd., Hsin-Chu (TW)

(21) Appl. No.: 10/802,268

(22) Filed: Mar. 17, 2004

(51) Int. Cl. G06F 11/30

(52) U.S. Cl. 702/182

(57) ABSTRACT

A system and method are provided for establishing a process parameter for manufacturing a semiconductor product prior to receiving manufacturing feedback regarding the process parameter. In one example, the method includes identifying a technology to which the process parameter is related and identifying at least one existing part manufactured using the identified technology. Information reflecting feedback data obtained while manufacturing the part may be retrieved and the process parameter may be calculated based on the retrieved information.

### BACKGROUND

The present disclosure relates generally to a system and method for manufacturing a semiconductor product and, more specifically, to a system and method for providing a process parameter for a first run of such a product.

Semiconductor foundries are involved in the production of semiconductor products. The fabrication of such products has generally increased in complexity with each generation of technology, and current products have increasingly small margins for error with respect to spacing, alignment, and similar issues. During the fabrication process, errors in areas such as alignment and focusing may occur because of incorrect process parameters. Such errors may be particularly prevalent when production first begins on a product, as there are no test results from previous product runs that may be used for setting or correcting parameters controlling the equipment and processes.

Accordingly, what is needed in the art is a system and method that addresses the above discussed issues.

### BRIEF DESCRIPTION OF THE DRAWINGS

FIG. 1 illustrates a flow chart of one embodiment of a method for calculating a process parameter for a first run during a semiconductor fabrication process.

FIG. 2 illustrates a schematic view of one embodiment of a virtual semiconductor fabrication environment within which the method of FIG. 1 may be executed.

FIG. 3 illustrates a more detailed example of the method of FIG. 1.

FIG. 4 illustrates an exemplary semiconductor substrate having alignment features that may be used by the system of FIG. 2.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

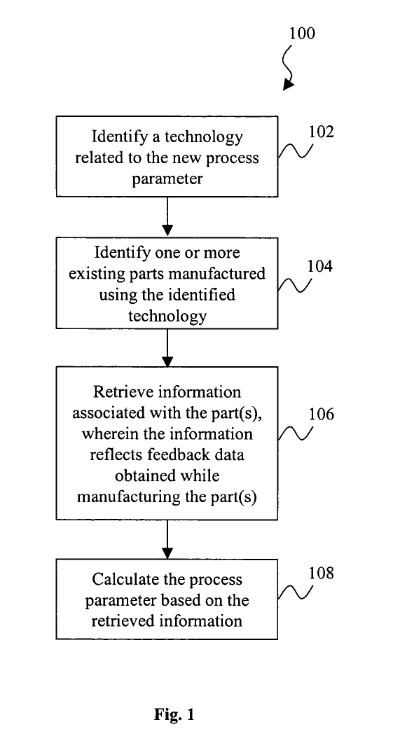

Referring to FIG. 1, in one embodiment, a method 100 may be used to establish a process parameter for use in manufacturing a semiconductor product prior to receiving manufacturing feedback regarding the process parameter. For example, the method 100 may be used for a “first run” of a product, which may involve a new device or the addition of a new component to an existing device, or may involve a new process step for a piece of equipment, an alternation in an existing process step, or a change to a mask or a layer. In general, a first run may result in a relatively high level of failure because there is no feedback data that may be used to make adjustments to the process. For example, when aligning different layers of a semiconductor device (as well as the photolithography equipment), a new process may involve a certain amount of “guesswork” that may only be resolved once the feedback data from the first run has been accumulated. The alignment of later runs may then be adjusted using the feedback data, which may result in an overall improvement in the process and a reduction in the rejection rate of the product.

As will be described later in greater detail with reference to a specific example, in step 102, a technology to which the process parameter (e.g., line width, alignment, rotation, etc.) is related may be identified. The technology may be identified by part type, line resolution, process step, or any other single criterion or combination of criteria. In step 104, one or more existing parts that were manufactured using the technology may be identified and, in step 106, information associated with the part may be retrieved. In the present example, the information reflects feedback data obtained while manufacturing the part. It is understood that the information may be retrieved based on the particular process parameter. For example, if the process parameter defines a rotational alignment setting, then the retrieved information may represent only rotational alignment settings for the parts. In step 108, the process parameter may be calculated or adjusted based on the retrieved information. For example, the process parameter may be calculated as a statistical value (e.g., an average value) based on the retrieved information. Accordingly, because the retrieved information is based on manufacturing feedback data and is associated with the process parameter at least through the similar technology, the retrieved information may provide guidance on setting the process parameter for the first run.

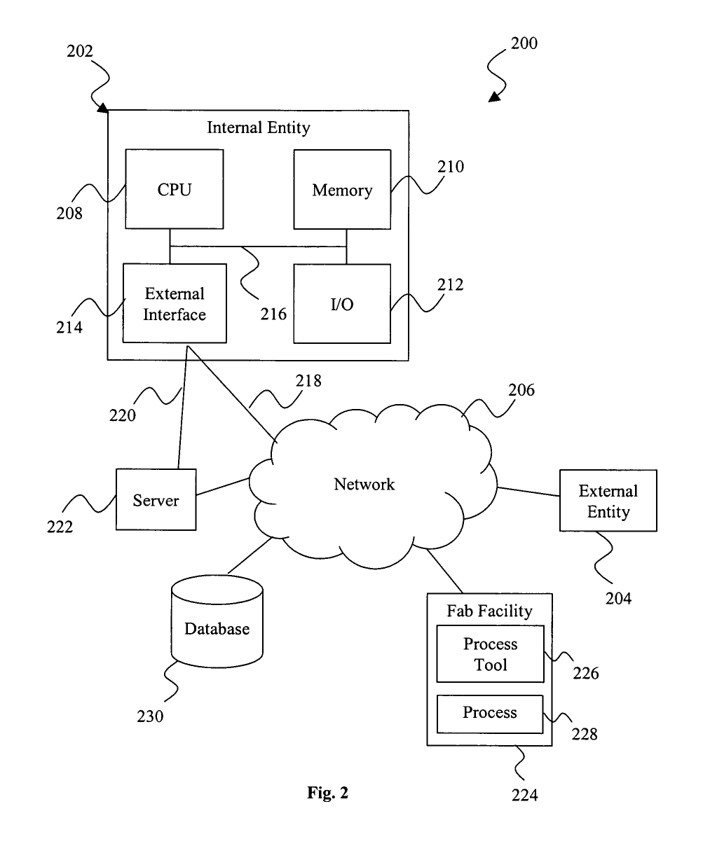

Referring now to FIG. 2, an exemplary virtual semiconductor fabrication (a “virtual fab”) environment 200 illustrates one embodiment of a system in which the method 100 of FIG. 1 may be implemented. The virtual fab 200 includes a plurality of entities represented by one or more internal entities 202 and one or more external entities 204 that are connected by a communications network 206. The network 206 may be a single network or may be a variety of different networks, such as an intranet and the Internet, and may include both wireline and wireless communication channels.

Each of the entities 202, 204 may include one or more computing devices such as personal computers, personal digital assistants, pagers, cellular telephones, and the like. For the sake of example, the internal entity 202 is expanded to show a central processing unit (CPU) 208, a memory unit 210, an input/output (I/O) device 212, and an external interface 214. The external interface may be, for example, a modem, a wireless transceiver, and/or one or more network interface cards (NICs). The components 208-214 are interconnected by a bus system 216. It is understood that the internal entity 202 may be differently configured and that each of the listed components may actually represent several different components. For example, the CPU 208 may actually represent a multi-processor or a distributed processing system; the memory unit 224 may include different levels of cache memory, main memory, hard disks, and remote storage locations; and the I/O device 212 may include monitors, keyboards, and the like.

The internal entity 202 may be connected to the communications network 206 through a wireless or wired link 218, and/or through an intermediate network 220, which may be further connected to the communications network. The intermediate network 220 may be, for example, a complete network or a subnet of a local area network, a company wide intranet, and/or the Internet. The internal entity 202 may be identified on one or both of the networks 206, 220 by an address or a combination of addresses, such as a MAC address associated with the network interface 214 and an IP address. Because the internal entity 202 may be connected to the intermediate network 220, certain components may, at times, be shared with other internal entities. Therefore, a wide range of flexibility is anticipated in the configuration of the internal entity 202. Furthermore, it is understood that, in some implementations, a server 222 may be provided to support multiple internal entities 202. In other implementations, a combination of one or more servers and computers may together represent a single entity.

In the present example, the internal entities 202 represents those entities that are directly responsible for producing the end product, such as a wafer or individually tested IC devices. Examples of internal entities 202 include an engineer, customer service personnel, an automated system process, a design or fabrication facility and fab-related facilities such as raw-materials, shipping, assembly or test. Examples of external entities 204 include a customer, a design provider, and other facilities that are not directly associated or under the control of the fab. In addition, additional fabs and/or virtual fabs can be included with the internal or external entities. Each entity may interact with other entities and may provide services to and/or receive services from the other entities.

It is understood that the entities 202, 204 may be concentrated at a single location or may be distributed, and that some entities may be incorporated into other entities. In addition, each entity 202, 204 may be associated with system identification information that allows access to information within the system to be controlled based upon authority levels associated with each entities identification information.

The virtual fab 200 enables interaction among the entities 202, 204 for purposes related to IC manufacturing, as well as the provision of services. In the present example, IC manufacturing can include one or more of the following steps:
receiving or modifying a customer's IC order of price, delivery, and/or quantity;
receiving or modifying an IC design;
receiving or modifying a process flow;
receiving or modifying a circuit design;
receiving or modifying a mask change;
receiving or modifying testing parameters;
receiving or modifying assembly parameters; and
receiving or modifying shipping of the ICs.

One or more of the services provided by the virtual fab 200 may enable collaboration and information access in such areas as design, engineering, and logistics. For example, in the design area, the customer 204 may be given access to information and tools related to the design of their product via the fab 202. The tools may enable the customer 204 to perform yield enhancement analyses, view layout information, and obtain similar information. In the engineering area, the engineer 202 may collaborate with other engineers 202 using fabrication information regarding pilot yield runs, risk analysis, quality, and reliability. The logistics area may provide the customer 204 with fabrication status, testing results, order handling, and shipping dates. It is understood that these areas are exemplary, and that more or less information may be made available via the virtual fab 200 as desired.

In the present example, a fab facility 224 (which may be an internal or external entity) includes a process tool 226 that may execute a process 228 to perform one or more semiconductor manufacturing steps. The process 228 may be a first run that would benefit from application of the method 100 of FIG. 1. Also included in the virtual fab 200 are one or more databases 230, which may store information relating to a plurality of parts, processes, process tools, etc. For example, the database 230 may store a plurality of part_IDs that identify a unique part within the virtual fab 200. Each part_ID may be associated within the database 230 with data representing various parameters for each part, such as alignment information, line widths, processing variables (e.g., temperature, pressure, duration, chemical compositions for etching, etc.). These parameters may reflect feedback data that was obtained during the manufacture of the part. Furthermore, each part_ID may be associated with a technology_ID that identifies a technology to which the part_ID belongs.

Computer-executable instructions may be stored on one or more of the internal and/or external entities to accomplish the method 100. Furthermore, in some embodiments, a specific software program or module may be used to provide an interface through which an engineer or other user may assign a technology type to the first run, select particular parts or processes for use in the calculations, modify the process parameter, and perform other functions. In other embodiments, the method 100 may be executed automatically within the virtual fab 200. In still other embodiments, certain steps may be automatically executed, while other steps may wait for or prompt a user for input. Accordingly, the method 100 may utilize the information from the database 230 to calculate a process parameter for a first run of the process 228 on the process tool 226.

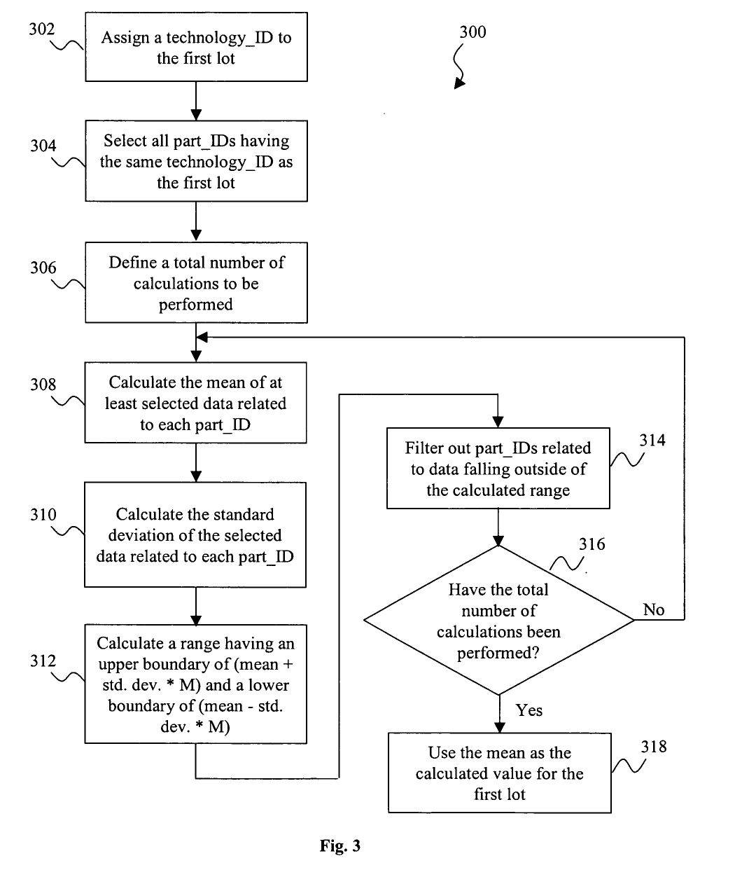

Referring now to FIG. 3, a method 300 illustrates a more detailed example of the method 100 of FIG. 1. The present example is applied to a first lot of semiconductor devices. It is noted that although the term “lot” is used for purposes of illustration, the method 300 may be applied to one or more wafers, devices, lots, batches, etc. (all of which are hereinafter referred to as lots). As previously described with respect to the first run of FIG. 1, the first lot may represent the introduction of a new component, device, process, mask, layer, etc., that may be part of or used to form a semiconductor device.

In step 302, a technology_ID may be assigned to the first lot. The technology_ID may be selected from a group of preexisting technology_IDs that exist within the virtual fab of FIG. 2. For example, the technology_ID may identify one or more of a line width, a specific alignment parameter (e.g., rotation, magnification, etc.), or other component or process parameters.

In step 304, all part_IDs having the same technology as the first lot are selected. It is understood that, in some embodiments, part_IDs may be filtered or otherwise selected using other criteria to narrow the number of part_IDs and/or to focus on part_IDs that are particularly relevant. In step 306, a total number of calculations (two in the present example) to be performed may be defined. This may involve, for example, incrementing a variable each time the calculations are performed and comparing the variable against the defined total number of calculations to determine if additional calculations are to be performed.

With additional reference to Table 1, below, five part_IDs TMA001-TMA005 are illustrated for purposes of example. Each part_ID is related to a feedback value that indicates feedback information obtained during the manufacturing of parts corresponding to the part_ID. As described previously, the feedback value may be retrieved based on the particular process parameter. For example, if a process parameter defines a rotational alignment setting, then the feedback values may represent only rotational alignment settings for the part_IDs.

In steps 308 and 310, a mean value and standard deviation are calculated using the five parts TMA001-TMA005. As shown in Table 1, the mean value is calculated as 0.496 and the standard deviation is calculated as 0.278.

TABLE 1

| Part ID | Feedback |
|---|---|
| TMA001 | .2 |
| TMA002 | .3 |
| TMA003 | .4 |
| TMA004 | .78 |
| TMA005 | .8 |
| Mean | .496 |
| Standard deviation (STD) | .278 |
| Mean + STD * M | .774 |
| Mean − STD * M | .218 |

In step 312, a range is calculated that has an upper boundary defined as the calculated mean plus the standard deviation times a constant value M (mean±std. dev.*M) and a lower boundary defined as the calculated mean plus the standard deviation times the constant value M (mean−std. dev.*M). The constant value M enables the range's size to be altered to be more inclusive (e.g., larger so as to encompass more part_IDs) or more exclusive (e.g., smaller so as to encompass fewer part_IDs). In the present example, with M=1, the upper boundary is equal to 0.774 and the lower boundary is equal to 0.218.

In step 314, part_IDs that fall outside of the range (e.g., above the upper boundary and below the lower boundary) may be filtered out. Accordingly, parts TMA001, TMA004, and TMA005, may be filtered out as they are associated with values of 0.2, 0.78, and 0.8, respectively. In step 316, a determination is made as to whether the total number of calculations defined in step 306 have been made. If not (as in the present example), the method 300 returns to step 308 and performs another calculation using the filtered part_IDs.

Steps 308-312 may be repeated using the remaining part_IDs TMA002 and TMA003. As illustrated below in Table 2, a new mean (0.35), standard deviation (0.071), upper boundary (0.421) and lower boundary (0.279) may be calculated.

TABLE 2

| Part ID | Feedback |
|---|---|
| TMA002 | .3 |
| TMA003 | .4 |
| Mean | .35 |
| Standard deviation (STD) | .071 |
| Mean + STD * M | .421 |
| Mean − STD * M | .279 |

In the present example, repeating step 314 does not filter out any additional part numbers. In step 316, another determination is made as to whether the total number of calculations defined in step 306 have been made. In the present case, as two calculations have been performed and the total number was set at two, the method continues to step 318, where the last calculated mean (0.35) is used as the calculated value for the first lot.

It is understood that, while the terms “mean” and “standard deviation” are used for purposes of example, other statistical methods, calculations, and/or results may be applied in place of or in addition to those described. Furthermore, the calculation of a range for filtering may be accomplished in different ways, may lack an upper or lower boundary, and may not be used at all in some embodiments.

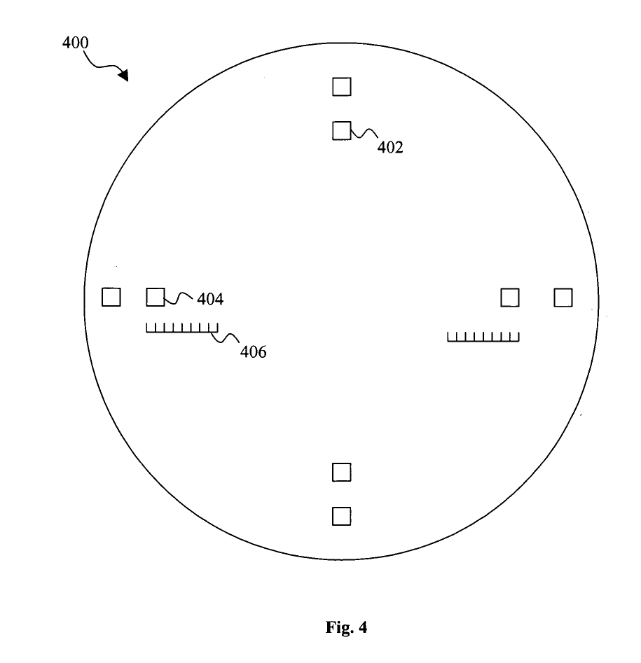

Referring to FIG. 4, illustrated is a schematic view of one embodiment of a semiconductor substrate 400 having a plurality of lithographic alignment features, including translational features 402, 404, and scale features 406. It is understood that additional features may be used to aid in alignment and to avoid translational and/or rotational misalignment, as well as to address magnification and/or focus problems.

In the present example, the translational features 402, 404 provide Cartesian X, Y, and Z alignment points for the alignment of the substrate 400 with an alignment mechanism, such as may be found in the process tool 226 of FIG. 2. For example, the alignment mechanism may include a plurality of He—Ne lasers to provide positioning of an optical stage of the process tool 226 and the substrate 400. The translational features 402, 404 may also aid in rotational alignment and focusing. The substrate 400 may have a plurality of different focus settings at differing locations. The scale features 406 may include incremental geometric dimensions spanning a plurality of distances according to a technological design category of the device.

The present disclosure has been described relative to a preferred embodiment. Improvements or modifications that become apparent to persons of ordinary skill in the art only after reading this disclosure are deemed within the spirit and scope of the application. It is understood that several modifications, changes and substitutions are intended in the foregoing disclosure and in some instances some features of the disclosure will be employed without a corresponding use of other features. Accordingly, it is appropriate that the appended claims be construed broadly and in a manner consistent with the scope of the disclosure.

1. A computer-executable method of establishing a process parameter for manufacturing a semiconductor product prior to receiving manufacturing feedback regarding the process parameter, the method comprising:
identifying a technology to which the process parameter is related;
identifying at least a first existing part manufactured using the identified technology;
retrieving information associated with the first existing part, wherein the information reflects feedback data obtained while manufacturing the first existing part; and
calculating the process parameter based on the retrieved information.

2. The computer-executable method of claim 1 wherein calculating the process parameter includes calculating a statistical value of the retrieved information.

3. The computer-executable method of claim 2 wherein the statistical value is an average, and wherein the average is used as the process parameter.

4. The computer-executable method of claim 1 further comprising:
identifying a second existing part manufactured using the identified technology;
retrieving information associated with the second existing part, wherein the information reflects feedback data obtained while manufacturing the second existing part;
filtering out information associated with the first and second parts that fails to meet at least one predefined criterion.

5. The computer-executable method of claim 4 further comprising defining a range of acceptable information for use in filtering, wherein the predefined criterion defines a boundary of the range.

6. The computer-executable method of claim 5 wherein defining the range includes calculating a mean and a standard deviation of the information.

7. The computer-executable method of claim 6 wherein an upper boundary of the range is defined based on the mean plus the standard deviation, and wherein a lower boundary of the range is defined based on the mean minus the standard deviation.

8. The computer-executable method of claim 7 wherein the upper and lower boundaries are recalculated a predefined number of times based on information not filtered out in the preceding calculation of the range.

9. The computer-executable method of claim 1 further comprising incorporating the calculated process parameter into a manufacturing process for the semiconductor product.

10. A method for execution on a computer for determining a process parameter value to be used in manufacturing a semiconductor product prior to receiving feedback regarding the manufacturing, wherein the process parameter is associated with a specific technology, the method comprising:
selecting one or more part identifiers representing parts based on the technology;
calculating a mean of at least selected data related to each part identifier; and
using the mean as the process parameter.

11. The method of claim 10 further comprising:
calculating a range; and
recalculating the mean using only selected data related to each part identifier that is within the range.

12. The method of claim 11 wherein calculating the range includes:
calculating a standard deviation of the selected data;
calculating an upper boundary of the range as the mean plus the standard deviation; and
calculating a lower boundary of the range as the mean minus the standard deviation.

13. The method of claim 12 further comprising multiplying the standard deviation by a constant value when calculating the upper and lower boundaries.

14. The method of claim 11 further comprising defining a total number of calculations to be performed, wherein the total number identifies a number of times that the mean is to be calculated after part identifiers are filtered out using the range.

15. The method of claim 10 further comprising assigning the specific technology to the process parameter.

16. A system for determining a process parameter value to be used in manufacturing a semiconductor product prior to receiving feedback regarding the manufacturing, the system comprising:
a semiconductor fabrication tool configured to execute a fabrication process using the process parameter value, wherein the process is associated with a specific technology;
a database configured to store information identifying a plurality of parts and associated manufacturing information, wherein each part is associated with a technology and wherein the manufacturing information reflects feedback data obtained by manufacturing the parts; and
a plurality of software instructions including:
instructions for identifying one or more parts from the database having the same technology as the process;
instructions for retrieving at least a portion of the manufacturing information associated with the identified parts from the database;
instructions for calculating a statistical value of the retrieved information; and
instructions for defining the process parameter value based on the statistical value.

17. The system of claim 16 further comprising:
instructions for calculating a range; and
instructions for recalculating the statistical value using only selected data related to each part identifier that is within the range.

18. The system of claim 17 wherein the statistical value is a mean and wherein the instructions for calculating the range include:
instructions for calculating a standard deviation of the selected data;
instructions for calculating an upper boundary of the range using the mean plus the standard deviation; and
instructions for calculating a lower boundary of the range using the mean minus the standard deviation.

19. The system of claim 18 further comprising instructions for multiplying the standard deviation by a predefined constant when calculating the upper and lower boundaries.

20. The system of claim 16 further comprising instructions for applying the process parameter value to the fabrication process.
